(19) United States
(12) Patent Application Publication
(10) Pub. No.: US 2010/0311016 A1
(43) Pub. Date: Dec. 9, 2010

(54) STEERING MECHANISM

(75) Inventors: Kishore Dutt Atluri, Hyderabad (IN); Samson Jayaprakash Anga, Hyderabad (IN)

Correspondence Address: WOODCOCK WASHBURN LLP, CIRA CENTRE, 12TH FLOOR, 2929 ARCH STREET, PHILADELPHIA, PA, 19104-2891, US

(73) Assignee: EN TECHNOLOGIES LIMITED, HYDERABAD (IN)

(21) Appl. No.: 12/812,922

(22) PCT Filed: Jan. 13, 2009
(86) PCT No.: PCT/IN09/00042

§ 371 Date: Jul. 14, 2010

(30) Foreign Application Priority Data
Jan. 14, 2008 (IN) 128/CHE/2008

(51) Int. Cl. G09B 9/04

(52) U.S. Cl. 434/62

(57) ABSTRACT

The invention describes a simulated steering apparatus provided with a base (2), a driving shaft (11) with a first and second ends. A first plate (21) is rigidly mounted to the driving shaft and a second plate (18) is freely mounted to the driving shaft. The first plate is disposed at a close proximity to the second plate. A friction means (19) is disposed between the first plate and the second plate. A motor (34) is operably connected to the second plate. A force exerting means (20), which is disposed in the vicinity of the first and the second plate, holds them together. A position sensing means (40) operably connected to the driving shaft, actuates the motor when the driving shaft is not in a neutral position. The motor is actuated, such that, the second plate rotates in a direction opposite to that of the first plate.

### TECHNICAL FIELD

The subject matter described herein in general relates to simulated mechanisms and in particular relates to a simulated steering apparatus.

### BACKGROUND

A simulator is a mechanism in which the behavior of a system is artificially replicated. Simulators are less complicated than actual mechanisms. This allows the designer to concentrate on certain aspects of the system that need to be simulated.

Vehicle simulators are widely used for teaching driving techniques. The driving console of such simulators generally includes a steering wheel, an accelerator, a brake pedal, a clutch and a gear actuator. The console is designed in such a way that it is responsive to the actuation of various controls provided in the console.

Steering wheel is one of the main components of the vehicle simulator that needs to be effectively controlled. When the driver turns the steering wheel, while seated inside the console, the console tilts accordingly. This acts as a feedback, thereby helping the driver to form a sound judgment. Such a training that is provided within a short period of time with the help of these vehicle simulators are much effective for drivers of all categories.

One particular example, where control of steering is of utmost importance is in a formula 1 car. Driving such a car without any prior experience can be really dangerous, as these cars are way too powerful to be handled by ordinary drivers. Hence, the prospective drivers are first trained in simulated environments using vehicle simulators. This gives us a clear indication that the vehicle simulators to be adjusted to a normal vehicle driving condition to any extreme conditions. This also suggests us that the mechanisms within the simulator are to be modified to suit varying driving conditions.

Simulators also find application in real time video gaming. Video games that are available these days include operating consoles for the gamers. The consoles are designed in such a way that they resemble a real vehicle. The gamer sits inside the console and controls the direction of the vehicle by looking at a screen, which is installed in front of the gamer.

Generally steering mechanism of the vehicle simulator is provided with complex assembly and functionalities. Such a steering mechanism often includes a spring to oppose the movement of the steering wheel, and to bring back the steering wheel to its original position. In such simulators, one end of the spring is connected to a driving shaft, and the other end is connected to a stationary member. When the steering wheel is in a neutral position, the spring does not exert any force. But, when the steering wheel is turned, the driving shaft connected to the steering wheel is consequently rotated, due to which a resisting force is developed in the spring. Due to this resistance, the driver feels a resistance at the steering wheel and this provides him a real time driving experience. In such simulators the spring always provides an almost constant resistance, further, if such a simulator is to be used to simulate the driving conditions for a different vehicle, then the spring has to be replaced. Due to this reason, the cost of the vehicle simulator is also high. Furthermore, the maintenance cost of such a simulator is also high. These factors decrease the versatility of the steering simulator.

Thus, it is desirable to have a simulated steering system which is simple, maintenance free and economic. Further, it should respond effectively to various controls so as to accurately replicate the behavior. Also, it should be flexible, so that it can simulate the behavior of different kinds of vehicles, without substantial modification and by providing a varying resistance.

### SUMMARY

The subject matter described herein is directed to a simulated steering apparatus that satisfies the need. The apparatus comprises a base, a driving shaft connected to a steering wheel, a motor, a force exerting means, a position sensing means and a friction means. The driving shaft is rotatably supported on the base. A first plate is rigidly mounted, while a second plate is freely mounted to the driving shaft. The first plate is disposed at a close proximity to the second plate. The motor is operably connected to the second plate. The force exerting means is disposed in the vicinity of the first and second plates, in such a way, that the force exerting means holds the first and second plate together. The position sensing means is operably connected to the driving shaft. The position sensing means actuates the motor when the driving shaft is not in a neutral position. The motor is actuated in such a way that the second plate rotates opposite to that of the first plate. A friction means is disposed between the first plate and the second plate.

These and other features, aspects, and advantages of the present subject matter will become better understood with reference to the following description and appended claims. This Summary is provided to introduce a selection of concepts in a simplified form. This Summary is not intended to identify key features or essential features of the claimed subject matter, nor is it intended to be used to limit the scope of the claimed subject matter.

### BRIEF DESCRIPTION OF DRAWINGS

The above and other features, aspects, and advantages of the subject matter will become better understood with regard to the following description, appended claims, and accompanying drawings where:

FIG. 1 shows a perspective view of a simulated steering apparatus according to one embodiment of the present subject matter.

FIG. 2 shows an exploded view of the simulated steering apparatus.

FIG. 3 shows another exploded view of the simulated steering apparatus.

FIG. 4 shows a front view of the simulated steering apparatus, in which the dust plates are removed.

FIG. 5 shows a sectional view of the simulated steering apparatus.

### DETAILED DESCRIPTION

The present subject matter relates to a simulated steering apparatus, which is used for the purpose of training drivers. Such simulated apparatuses are also used in video games for providing a real time experience to the gamer. The apparatus comprises a base 2, a driving shaft 11, a first plate 21, a second plate 18, a motor 34, a force exerting means 20, a friction means 19 and a position sensing means 40. The force exerting means 20 keeps the first plate 21 and the second plate 18 attracted towards each other so that both the plates are in contact with each other. When the driving shaft 11 is rotated, the position sensing means 40 senses the movement and actuates the motor 34. The motor 34 is actuated in such a manner that the plate 18 rotates in a direction opposite to the direction of rotation of the plate 21. Hence, the tendency of the motor 34 is to bring back the steering wheel to its original position and this very tendency gives the operator the feel of a real time driving experience.

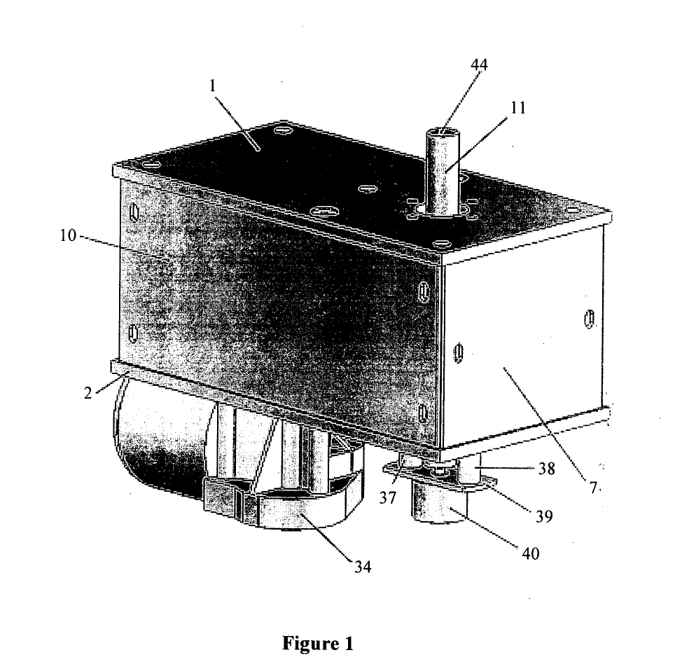

FIG. 1 shows a perspective view of a simulated steering apparatus in accordance with the present subject matter. The simulated steering apparatus comprises four dust plates 7, 8, 9 and 10. Dust plates 8 and 9 are not visible in this figure. A steering wheel is provided at an end 44 of the driving shaft 11. The driving shaft 11 is rotatably supported in the base 2 and is connected to a position sensing means i.e. a sensor 40, with the help of a sensor fixing plate 39. The driving shaft 11 attains a neutral position when the vehicle is following a straight line path. Whenever the operator turns the steering wheel, the driving shaft 11 is displaced from its neutral position. This displacement of the driving shaft 11 is sensed by the sensor 40. The sensor 40 sends a signal and actuates a motor 34. The motor 34 opposes the motion of the driving shaft 11 and tries to bring back the driving shaft 11 to the neutral position. The apparatus is covered at top, above with the help of a top plate 1.

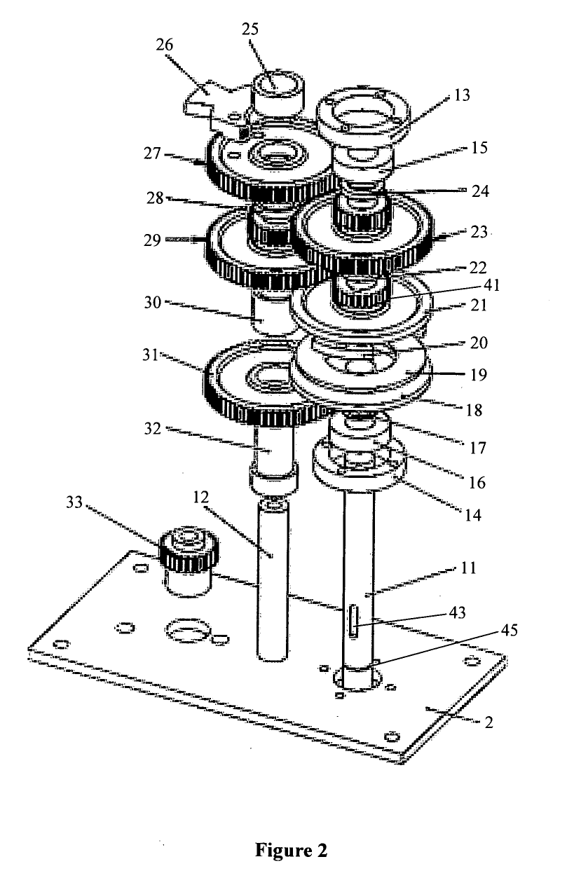

FIG. 2 shows an exploded view of the simulated steering apparatus. A bearing holder 13 is mounted on the top plate 1 to accommodate a bearing 15. A spacer 24 and a spacer 22 are placed above and below a double gear 23 (also referred to as a “first double gear”) respectively. A plate 21 is having a force exerting means, i.e. a magnet 20, attached to one side. A gear 41 is attached to the other side of the plate 21. A keyway is provided in the gear 41. A plate 18 is having a friction means, i.e. a friction plate 19, attached to its first side and a gear 42 (not shown in the fig.) attached to its second side. A cir-clip 17 fits into a groove 45 that is provided in the driving shaft 11, and the bearing 16 is accommodated in a bearing holder 14. A keyway 43 corresponding to a keyway 46 in the gear 41 is provided in the driving shaft 11. The gear 41 is keyed to the driving shaft 11 with the help of a key (not shown in the fig.), which is placed in the keyway 46 and the corresponding keyway 43.

A shaft 12 (also referred to as a “rigid shaft”) is fixed to the base 2. A gear 31 with a bush 32 is mounted on the shaft 12. A spacer 30 is placed over the gear 31 and a double gear 29 is placed above the spacer 30. A bush 28 is placed between the double gear 29 (also referred to as a “second double gear”) and a stopper gear 27. A spacer 25 is placed over the stopper gear 27 to which a stopper plate 26 is fixed. A pinion 33 is connected to a motor 34 (not shown in the figure).

When assembled, bearings 15 and 16 support the driving shaft 11. Bearing holders 13 and 14 accommodate the bearings 15 and 16 respectively. The cir-clip 17 prevents the assembly from moving downwards beyond the groove 45; as such a downward movement can damage the bearing 16. Due to the magnet 20, the plates 21 and 18 are pulled towards each other. The friction plate 19 is clutched between plates 21 and 18, due to the magnetic force exerted by the magnet 20. A keyway 46 is provided in the gear 41. A key is accommodated in the keyway 41 and the keyway 43. As a result, when the driving shaft 11 is rotated, due to the actuation of the steering wheel, the gear 41 rotates. Thus, the motion is first transmitted from the driving shaft 11 to the gear 41. Due to this, the plate 21 that is connected to the driving shaft 11 also rotates. The plate 21 experiences resistance from the friction plate 19. The friction is further increased due to the magnetic force exerted by the magnet 20. The sensor 40 senses the rotation of the driving shaft 11 and actuates the motor 34. As a result the pinion 33 rotates, which further rotates the gear 31. The rotation of the motor is in such a way that the plate 18 rotates in a direction opposite to that of plate 21. This opposite rotation of the plate 18 results in a resistance being offered to the rotation of the plate 21, due to which the user gets a feeling as if he is driving a real time vehicle. Double gears 29, 23 and the gear 27 are used for the purpose of gear reduction. These gears decide, how many turns the steering wheel can take, before attaining one extreme position. The dimensions of these gears can be changed according to the requirements.

The bush 32 adjusts the vertical position of the gear 31, so that the teeth of the gear 31 mesh with the teeth of the pinion 33. The spacer 30 is also provided for adjusting the vertical position of the double gear 29. The bush 28 is used for reducing the friction between the double gear 29 and the gear 27. The spacer 24 prevents the bearing 15 from coming into contact with the double gear 23.

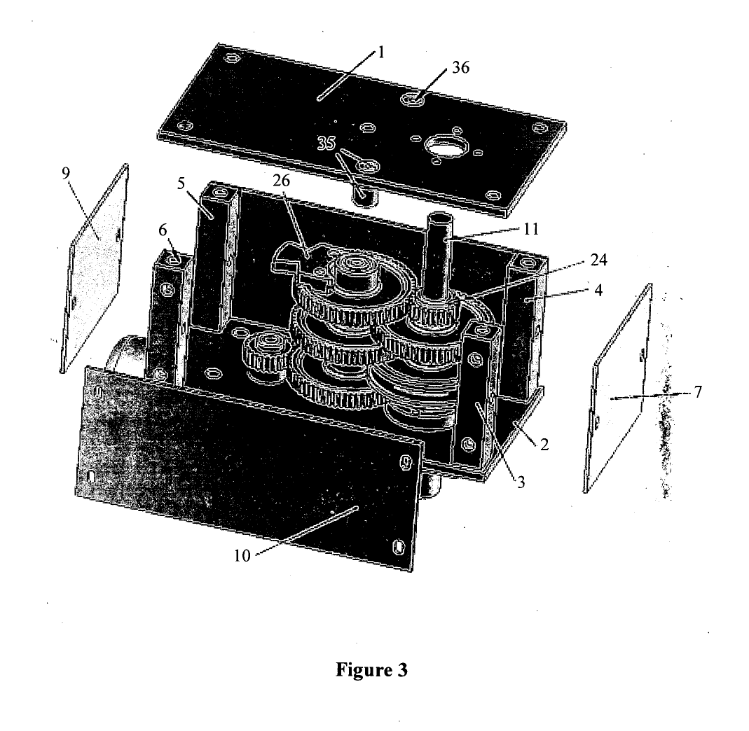

FIG. 3 shows another exploded view of the simulated steering apparatus. A plurality of pillars 3, 4, 5 and 6 are fixed to the base 2 and are accommodated in corresponding openings of the top plate 1. The stopper 35 (also referred to as a “first stopper”) and the stopper 36 (also referred to as a “second stopper”) are provided in the top plate 1 for restricting the movement of the stopper plate 26 in either direction. The assembly is shown as assembled, except that the box is shown as exploded.

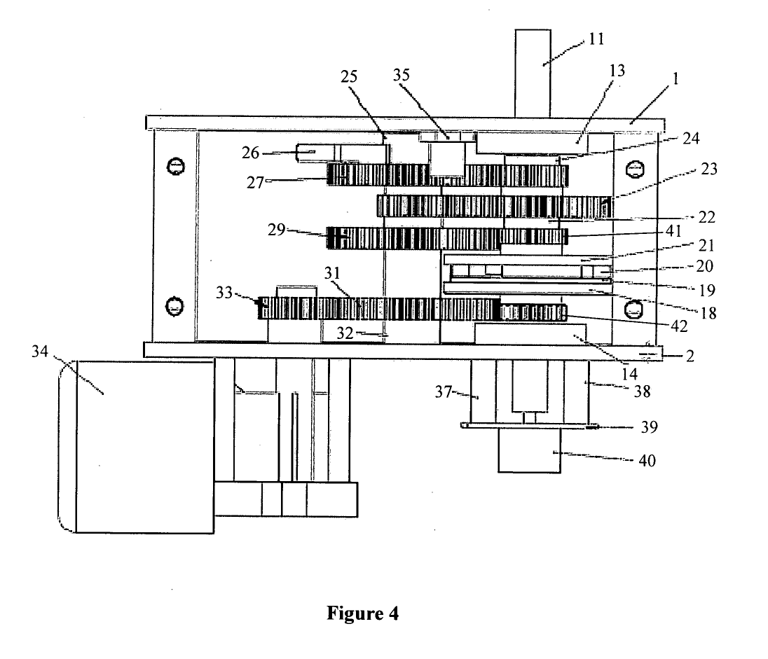

FIG. 4 shows a front view of the simulated steering apparatus, in which the dust plates are removed. The bush 32 adjusts the vertical position of the gear 31 on the shaft 12, such that, the pinion 33 operably comes into contact with the gear 31, which is operably in contact with the gear 42. The friction plate 19 is connected to the plate 18, while the magnet 20 is connected to the plate 21. Due to the magnetic force exerted by the magnet 20, the plate 21 is attracted towards the plate 18. The rotation of the driving shaft 11 subsequently rotates the plate 21. A substantial resistance is offered to the rotation of the plate 21 due to the friction offered by the friction plate 19. This friction is further increased due to the magnetic pull exerted by the magnet 20. The overall friction thus created provides a resistance to the rotation of the steering wheel by the driver. Such a resistance provides the driver a real time experience of driving. The sensor 40 senses the direction and the magnitude of rotation of the driving shaft 11 and sends a signal to the motor 34, thereby actuating the motor 34, so as to oppose the movement of the driving shaft 11.

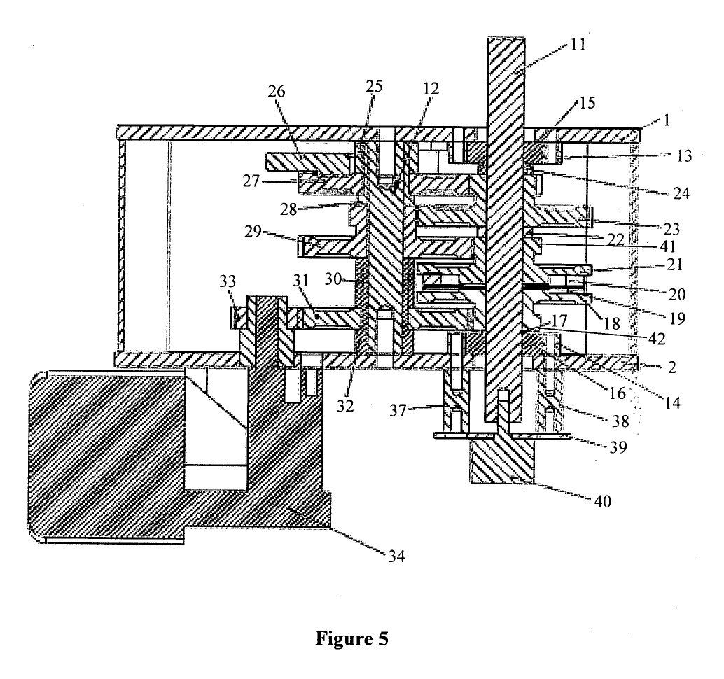

FIG. 5 shows a sectional view of the simulated steering apparatus. The cir-clip 17 is shown accommodated in the groove 45 that is provided in the driving shaft 11. The bush 28 and the bush 32 are provided to reduce the frictional effects and to prevent overheating of the apparatus. Working of the apparatus is described by dividing the apparatus into three mechanisms:

In the first mechanism, the plate 21 is keyed to the driving shaft 11. The plate 21 rotates when the driving shaft 11 is rotated. Due to the magnetic force exerted by the magnet 20, the plate 21 is attracted towards the plate 18. The plate 21 comes in contact with the friction plate 19. Due to this, the rotation of the driving shaft 11 is resisted.

In the second mechanism, the sensor 40 is operably connected to the driving shaft 11 at its lower end. When the driving shaft 11 is rotated in one direction, the sensor 40 senses the rotation of the driving shaft 11. The sensor 40 sends a signal to the motor 34, thereby actuating the motor 34, such that the motor 34 rotates in a direction opposite to the direction of rotation of the driving shaft 11. For example, if the driving shaft 11 is rotated in a clockwise direction, the plate 21 rotates with the driving shaft 11 in the clockwise direction. The sensor 40 actuates the motor 34 in an anti-clockwise direction, thereby rotating the pinion 33 in the anti-clockwise direction. The gear 31 is operably in contact with the pinion 33 and rotate in a clockwise direction. Because of this, the gear 42 rotates in an anti-clockwise direction that subsequently rotates the plate 18 in the anti-clockwise direction. Thus, the anti-clockwise rotation of the plate 18 and the clockwise rotation of the plate 21 results in resisting the movement of the driving shaft 11. The presence of the magnet 20 and the friction plate 19 further increases the resistance. The sensor 40 sends a signal, such that, when the driving shaft 11 is at one extreme position, the opposing motion of the motor 34 i.e. the total number of rotations of the motor 34 is high. As the driving shaft 11 approaches its neutral position, the opposition by the motor 34 decreases gradually.

In the third mechanism, when the driving shaft is rotated, the plate 21 is also rotated. The gear 41, which is attached to the plate 21, also rotates, thereby imparting motion to the double gear 29. The double gear 29 further transmits motion to the double gear 23. From the double gear 23, motion is transmitted to the stopper gear 27. Double gears 29 and 23 result in gear reduction. When the steering wheel reaches one extreme position, the stopper plate 26 comes into contact with either of the stoppers 35 or 36, thereby stopping any further rotation of the steering wheel by the driver.

The previously described versions of the subject matter and its equivalents thereof have many advantages, including those which are described below. The subject matter described is simple, easy to assemble, maintenance free and economic. Also, the modular construction results in a capability to adapt to any kind of steering system of any vehicle. The apparatus is small in size and hence is easy to transport.

Although the subject matter has been described in considerable detail with reference to certain preferred embodiments thereof, other embodiments are possible. As such, the spirit and scope of the appended claims should not be limited to the description of the preferred embodiment contained therein. For example, the number of teeth and the radius of gears can be varied, so as to vary the maximum angle through which the steering can be steered. An electromagnet or a spring can also be used as a force exerting means. A sensor can also be used to control the properties of the electromagnet. A plate having its one face grounded, so as to offer a resistance can also be used in the place of a friction plate.

I/We claim:

1. A simulated steering apparatus comprising:
a base (2);
a driving shaft (11) comprising a first end (44) and a second end, wherein
a steering wheel is connected to said first end (44),
said driving shaft (11) is rotatably supported in said base (2), a first plate (21) is rigidly mounted to said driving shaft (11) and a second plate (18) is freely mounted to said driving shaft (11), and wherein
said first plate (21) is disposed at a close proximity to said second plate (18);
a friction means (19) disposed between said first plate (21) and said second plate (18);
a motor (34) operably connected to said second plate (18);
a force exerting means (20) disposed in vicinity of said first plate (21) and said second plate (18), wherein
said force exerting means (20) holds said first plate (21) and said second plate (18) together; and
a position sensing means (40) operably connected to said driving shaft (11), wherein
said position sensing means (40) actuates said motor (34) when said driving shaft (11) is not in a neutral position, and wherein,
said motor (34) is actuated, such that,
said second plate (18) rotates in a direction opposite to that of said first plate (21).

2. The simulated steering apparatus as claimed in claim 1, wherein said first plate (21) is rigidly mounted on said driving shaft (11) by a key.

3. The simulated steering apparatus as claimed in claim 1, wherein said motor (34) is operably connected to said driving shaft (11) through a plurality of gears (29, 23).

4. The simulated steering apparatus as claimed in claim 1 or claim 3, wherein a first stopper (35) and a second stopper (36) that are mounted on a top plate (1) prevents complete rotation of a stopper plate (26), which is mounted on a rigid shaft (12), thereby controlling the rotation of said driving shaft (11).

5. The simulated steering apparatus as claimed in claim 1, wherein said force exerting means (20) is a permanent magnet.

6. The simulated steering apparatus as claimed in claim 1, wherein said force exerting means (20) is an electromagnet.

7. The simulated steering apparatus as claimed in claim 1, wherein said force exerting means (20) is a spring.

8. The simulated steering apparatus as claimed in claim 1, wherein said position sensing means (40) is operably connected to said second end of said driving shaft (11).

9. The simulated steering apparatus as claimed in claim 1, wherein said friction means is a friction plate (19), which is attached to said second plate (18).

10. The simulated steering apparatus as claimed in claim 1, wherein said steering wheel is connected to said first end (44) of said driving shaft (11) through a steering rod.
